(19) United States
(12) Patent Application Publication
(10) Pub. No.: US 2018/0160453 A1
(43) Pub. Date: Jun. 7, 2018

(54) METHOD AND APPARATUS FOR ALLOCATING RESOURCES FOR RANDOM ACCESS CHANNEL IN WIRELESS COMMUNICATION SYSTEM

(71) Applicant: Samsung Electronics Co., Ltd., Suwon-si, Gyeonggi-do (KR)

(72) Inventors: Nam-Jeong LEE, Suwon-si (KR); Peng XUE, Suwon-si (KR); Cheol JEONG, Seongnam-si (KR)

(21) Appl. No.: 15/566,496

(22) PCT Filed: Apr. 14, 2016
(86) PCT No.: PCT/KR2016/003905

§ 371 Date: Oct. 13, 2017

Related U.S. Application Data
(60) Provisional application No. 62/147,273, filed on Apr. 14, 2015.
(60) Provisional application No. 62/276,468, filed on Jan. 8, 2016.

(51) Int. Cl. H04W 74/08; H04W 72/04

(52) U.S. Cl. CPC H04W 74/0833; H04W 72/04

(57) ABSTRACT

The present disclosure relates to a 5G or pre-5G communication system for supporting a higher data transmission rate than a 4G communication system such as LTE. A method for performing, by a terminal, random access in a wireless communication system, according to an embodiment of the present disclosure, comprises the steps of: receiving, from a base station, system information including configuration information of resources allocated for random access allocated on the basis of at least one of a user group and a coverage class; identifying, from the configuration information, configuration information of resources for random access, corresponding to the user group in which the terminal is included, or the coverage class of the terminal; and transmitting a random access request to the base station using resources corresponding to the identified configuration information of the resources for random access.

### PRIORITY

This application is a National Phase Entry of PCT International Application No. PCT/KR2016/003905, which was filed on Apr. 14, 2016, and claims priorities to U.S. Provisional Patent Applications Nos. 62/147,273 and 62/276,468, which were filed on Apr. 14, 2015 and Jan. 8, 2016, the contents of which are incorporated herein by reference.

### TECHNICAL FIELD

The present disclosure relates to a method and apparatus for allocating resources for a random access channel (RACH) in a wireless communication system supporting multiple users.

### BACKGROUND ART

To satisfy demands for wireless data traffic having increased since commercialization of 4^{th}-Generation (4G) communication systems, efforts have been made to develop improved 5^{th}-Generation (5G) communication systems or pre-5G communication systems. For this reason, the 5G communication system or the pre-5G communication system is also called a beyond-4G-network communication system or a post-Long Term Evolution (LTE) system.

To achieve a high data rate, implementation of the 5G communication system in an ultra-high frequency (mmWave) band (e.g., a 60 GHz band) is under consideration. In the 5G communication system, beamforming, massive multi-input multi-output (MIMO), full dimensional MIMO (FD-MIMO), an array antenna, analog beamforming, and large-scale antenna technologies have been discussed to alleviate a propagation path loss and to increase a propagation distance in the ultra-high frequency band.

For system network improvement, in the 5G communication system, techniques such as an evolved small cell, an advanced small cell, a cloud radio access network (RAN), an ultra-dense network, a device to device (D2D) communication, a wireless backhaul, a moving network, cooperative communication, coordinated multi-points (CoMPs), and interference cancellation have been developed.

In the 5G system, advanced coding modulation (ACM) schemes including hybrid frequency-shift keying (FSK) and quadrature amplitude modulation (QAM) modulation (FQAM) and sliding window superposition coding (SWSC), and advanced access schemes including filter bank multi carrier (FBMC), non-orthogonal multiple access (NOMA), and sparse code multiple access (SCMA) have been developed.

Machine type communication (MTC), which is one of techniques researched in a 5G system, gives a sensor/communication function to every object to intelligently collect information and deliver the information to each other. M2M communication or IoT is used as the same meaning as the MTC. As a communication technique for the MTC, short-range communication and remote-range communication. Short-range communication for the MTC may include communication schemes that do not have broad service coverages such as Bluetooth, Bluetooth Low Energy (BLE), near field communication (NFC), wireless fidelity (Wi-Fi), and so forth. There exist MTC implementation (hereinafter, referred to as cellular MTC) having a broad service coverage and various non-standardized techniques, for example, SIGFOX, On-Ramp, a technology of the company Weightless, and so forth. In the 3GPP LTE standards, a standard for the MTC is under establishment, and some operators are developing the MTC-related operation by using the current cellular network. Generally, information exchanged between devices in cellular MTC varies with a type of an application, but usually has a low data rate and a low duty cycle and is less sensitive to latency.

As cellular MTC related standardization, there may be 3GPP GERAN Cellular IoT (CIoT) standardization, 3GPP LTE enhanced-MTC standardization, and 3GPP LTE narrowband (NB)-IoT standardization. In the 3GPP LTE NB-IoT standardization, a type of a terminal is designated as two types corresponding to a terminal capable of transmitting multiple tones and a terminal capable of transmitting a single tone, and a coverage class per terminal type is introduced. For reference, the terminal capable of transmitting multiple tones may be supported also in a mode transmitting only a single tone. CIoT standardization has a target for supporting a higher maximum coupling loss (MCL), and a coverage class of each terminal may be determined according to an MCL level needed by the terminal. Moreover, different modulation and coding schemes (MCS) for each terminal type and coverage class may be used, and a resource for random access may be designated. Therefore, when a resource for a random access channel is allocated in a cellular MTC-based communication system, a scheme for considering a type and a coverage class of terminals is needed.

### DETAILED DESCRIPTION OF THE INVENTION

### Technical Problem

The present disclosure proposes a method and apparatus for allocating resources for a random access channel in a wireless communication system supporting multiple users.

### Technical Solution

A method for performing random access by a user equipment (UE) in a wireless communication system according to an embodiment of the present disclosure includes receiving system information (SI) comprising configuration information of a resource allocated by a base station (BS) for random access based on at least one of a UE group and a coverage class, identifying the configuration of the resource for random access, which corresponds to a UE group to which the UE belongs or a coverage class of the UE, from the SI, and transmitting a random access request to the BS by using the resource corresponding to the identified configuration information of the resource for the random access.

A method for allocating a resource for random access by a base station (BS) in a wireless communication system according to an embodiment of the present disclosure includes allocating a resource for the random access based on at least one of a UE group and a coverage class for each UE, transmitting configuration information corresponding to the resource for the random access through SI, and receiving a random access request transmitted using the resource for the random access, which corresponds to the configuration information, from a UE.

A UE for performing random access in a wireless communication system according to an embodiment of the present disclosure includes a receiver configured to receive SI comprising configuration information of a resource allocated by a base station (BS) for random access based on at least one of a UE group and a coverage class, a controller configured to identify the configuration of the resource for random access, which corresponds to a UE group to which the UE belongs or a coverage class of the UE, from the SI, and a transmitter configured to transmit a random access request to the BS by using the resource corresponding to the identified configuration information of the resource for the random access.

A base station (BS) for allocating a resource for random access in a wireless communication system according to an embodiment of the present disclosure includes a controller configured to allocate a resource for the random access based on at least one of a UE group and a coverage class for each UE, a transmitter configured to transmit configuration information corresponding to the resource for the random access through SI, and a receiver configured to receive a random access request transmitted using the resource for the random access, which corresponds to the configuration information, from a UE.

Other aspects, advantages, and key features of the present disclosure will be processed together with the attached drawings, and will be apparent to those of ordinary skill in the art from the following detailed description disclosing various embodiments of the present disclosure.

Before undertaking the DETAILED DESCRIPTION OF THE INVENTION below, it may be advantageous to set forth definitions of certain words and phrases used throughout this patent document: The terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system or part thereof that controls at least one operation, and such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

FIG. 1A illustrates an example of a physical random access channel (PRACH) resource configuration allocated based on three coverage classes according to an embodiment of the present disclosure;

FIG. 1B illustrates an example of PRACH configuration information according to an embodiment of the present disclosure;

FIG. 2 is an example of a flowchart for determining a coverage class and configuring an RACH according to an embodiment of the present disclosure;

FIG. 3A is a block diagram of a base station (BS) according to an embodiment of the present disclosure;

FIG. 3B is an example of a flowchart illustrating operations of a BS according to an embodiment of the present disclosure;

FIG. 4A is a block diagram of a user equipment (UE) according to an embodiment of the present disclosure; and

FIG. 4B is an example of a flowchart illustrating operations of a UE according to an embodiment of the present disclosure.

### MODE FOR CARRYING OUT THE INVENTION

Hereinafter, embodiments of the present disclosure are described in detail with reference to the accompanying drawings. In the following description of the present disclosure, a detailed description of well-known functions or elements associated with the present disclosure will be omitted if it unnecessarily obscures the subject matter of the present disclosure. The terms as used herein are defined considering the functions in the present disclosure and may be replaced with other terms according to the intention or practice of the user or operator. Therefore, the definitions should be made based on the contents throughout the entire description of the present disclosure.

Various changes may be made to the present disclosure and the present disclosure may have various embodiments which will be described in detail with reference to the drawings. However, the embodiments according to the concept of the present disclosure are not construed as limited to specified disclosures, and include all changes, equivalents, or substitutes that do not depart from the spirit and technical scope of the present disclosure.

It is to be understood that the singular forms “a,” “an,” and “the” include plural referents unless the context clearly dictates otherwise. Thus, for example, a component surface includes one or more component surfaces. Although the terms such as “first” and “second” used in the various exemplary embodiments of the present disclosure may modify various elements of the various exemplary embodiments, these terms do not limit the corresponding elements. These terms may be used for the purpose of distinguishing one element from another element. For example, a first element may be named as a second element without departing from the right scope of the various exemplary embodiments of the present disclosure, and similarly, a second element may be named as a first element. The term “and/or” includes a combination of a plurality of related provided items or any one of the plurality of related provided items. The terms used in the various exemplary embodiments of the present disclosure are for the purpose of describing particular exemplary embodiments only and are not intended to be limiting. The singular forms are intended to include the plural forms as well, unless the context clearly indicates otherwise. The term “include” or “has” used in the exemplary embodiments of the present disclosure is to indicate the presence of features, numbers, steps, operations, elements, parts, or a combination thereof described in the specifications, and does not preclude the presence or addition of one or more other features, numbers, steps, operations, elements, parts, or a combination thereof. All of the terms used herein including technical or scientific terms have the same meanings as those generally understood by an ordinary skilled person in the related art unless they are defined other. The terms defined in a generally used dictionary should be interpreted as having the same meanings as the contextual meanings of the relevant technology and should not be interpreted as having ideal or exaggerated meanings unless they are clearly defined in the various exemplary embodiments. According to various embodiments of the present disclosure, an electronic device may include a communication function. For example, an electronic device may include a smartphone, a tablet personal computer (PC), a mobile phone, a video phone, an electronic-book (e-book) reader, a desktop PC, a laptop PC, a netbook computer, a workstation, a server, a personal digital assistant (PDA), a portable multimedia player (PMP), an MP3 player, a mobile medical equipment, a camera, and a wearable device (e.g., a head-mounted device (HMD), electronic clothing, an electronic bracelet, an electronic necklace, an electronic appcessory, an electronic tattoo, or a smart watch.

According to various embodiments of the present disclosure, the electronic device may be a smart home appliance having a communication function. For example, the smart home appliance may include a TV, a digital video disk (DVD) player, audio equipment, a refrigerator, an air conditioner, a vacuum cleaner, an oven, a microwave oven, a washer, a drier, an air cleaner, a set-top box, a TV box (e.g., HomeSync™ of Samsung, TV™ of Apple, or TV™ of Google), a game console, an electronic dictionary, a camcorder, and an electronic frame.

According to various embodiments of the present disclosure, the electronic device may include medical equipment (e.g., a magnetic resonance angiography (MRA) device, a magnetic resonance imaging (MRI) device, a computed tomography (CT) device, an imaging device, or an ultrasonic device), a navigation system, a global positioning system (GPS) receiver, an event data recorder (EDR), a flight data recorder (FDR), a vehicle infotainment device, electronic equipment for ships (e.g., a navigation system, gyroscope, and gyro compass for ships), avionics, a security device, an industrial or home robot, and so forth.

According to various embodiments of the present disclosure, the electronic device may include a part of a furniture or building/structure having a communication function, an electronic board, an electronic signature receiving device, a projector, and various measuring instruments (for example, a water, electricity, gas, or electric wave measuring device), mobile devices, e.g., mobile phones, and so forth. According to various embodiments of the present disclosure, the electronic device may be a combination of the above-described devices. It will be obvious to those of ordinary skill in the art that the electronic device according to various embodiments of the present disclosure is not limited to the above-listed devices.

According to various embodiments of the present disclosure, a user equipment (UE) may be, for example, an electronic device.

A method and apparatus proposed in an embodiment of the present disclosure are applicable to various communication systems such as an Institute of Electrical and Electronics Engineers (IEEE) 802.11ac communication system, an IEEE 802.16 communication system, a digital multimedia broadcasting (DMB) service, a digital video broadcasting-handheld (DVB-H) service, and a mobile broadcasting service such as an Advanced Television Systems Committee-Mobile/Handheld (ATSC-M/H) service, a digital video broadcasting system such as an Internet protocol television (IPTV) service, an Moving Picture Experts Group (MPEG) media transport (MMT) system, an evolved packet system (EPS), an Long Term Evolution (LTE) communication system, an LTE-Advanced (LTE-A) communication system, a high-speed downlink packet access (HSDPA) mobile communication system, a high-speed uplink packet access (HSUPA) mobile communication system, a 3rd-Generation (3G) Project Partnership 2 (3GPP2) high rate packet data (HRPD) mobile communication system, a 3GPP2 wideband code division multiple access (WCDMA) mobile communication system, a 3GPP2 code division multiple access (CDMA) mobile communication system, a mobile Internet protocol (IP), and so forth.

For convenience, an embodiment of the present disclosure proposes a method and apparatus for allocating a resource (hereinafter, referred to as an RACH resource) for a random access channel (RACH) and configuring the allocated RACH resource in a wireless communication system supporting multiple users, for example, in a frequency division multiplexing (FDM) or orthogonal frequency division multiplexing (OFDM)-based wireless communication system. For the sake of convenience, a UE according to an embodiment of the present disclosure will be described, for example, as an electronic device supporting an MTC function. However, an embodiment of the present disclosure is not limited to an electronic device supporting an MTC function, and is also applicable to UEs supporting other communication functions.

More specifically, it is assumed in an embodiment of the present disclosure that user equipments (UEs) are classified into multiple UE groups, and there is an MCS table for applying a different MCS for a different UE group. Herein, the MCS information forming the MCS table may include, for example, a modulation scheme, a code rate, the number of repetitions, a spreading length, and the like. A UE group-specific MCS table according to an embodiment of the present disclosure is assumed to be shared in advance between a base station (BS) and a UE.

Generally, if the UE has not yet been connected with a network or needs to be allocated with a new UL or DL resource when the UE is connected with the network, the UE may deliver a random access request message that requests data resource allocation and a temporary ID from the BS through the RACH. To this end, the BS allocates an RACH resource related to a procedure for a UE to connect to a network, and delivers RACH configuration information corresponding to the allocated RACH resource through system information (SI) in a broadcast channel or a control channel. The UE then identifies the RACH configuration information from the received SI and performs random access based on the identified RACH configuration information. Generally, when multiple users perform random access, a random access request of each user may be classified as for a sequence or time-frequency resource. Locations of a time and a frequency of an RACH resource allocated to the entire system may be designated in advance, or may be flexibly allocated through the RACH configuration information. Therefore, an embodiment of the present disclosure proposes a scheme in which a BS allocates an RACH resource considering at least one of a UE group and a coverage class, configures RACH configuration information including location or configuration information of the allocated RACH resource and delivers the configured RACH configuration information to the UE, and the UE performs random access based on the RACH configuration information according to an embodiment of the present disclosure.

UE Group Designation Scheme

Prior to a method for allocating an RACH resource, a scheme for designating a UE group according to an embodiment of the present disclosure is as described below. According to an embodiment of the present disclosure, a UE may directly determine a UE group or, according to an embodiment, a BS may designate a UE group of the UE. First, if the UE directly determines a UE group, one UE may select one UE group for predetermined multiple UE groups and operates, or may operate as two or more UE groups. If the UE operates as two or more UE groups, it means that the UE may selectively operate as one UE group depending on a circumstance. Next, if the BS determines a UE group of a UE, the BS determines a UE group of the UE, includes information of the determined UE group in the SI, and delivers the information in a control channel. For example, the BS may designate the UE group of the UE based on the coverage class of the UE. In this case, the BS may include UE group designation information per coverage class in the SI and deliver the UE group designation information to the UE. More specifically, suppose that the coverage class is divided into a total of three partial regions corresponding to basic, normal, and extreme, including each preset path loss range based on a path loss between a UE and a BS. Herein, it is assumed that retransmission (the number of repetitive transmissions of an identical signal) for compensating for a path loss decreasing according to a range having a higher path loss value in a direction from the basic coverage class to the extreme coverage class increases. In this case, the BS may designate UEs corresponding to the basic and normal coverage classes as a UE group A, and a UE corresponding to the extreme coverage class as a UE group B. The BS may transmit UE_group_per_CoverageClass information indicating UE class designation information per coverage class through SI. For example, if the UE corresponding to the basic and normal coverage classes identifies UE_group_per_CoverageClass that is set to 001 from SI received from the BS, then the user may recognize that the user is designated as the UE group A. Likewise, the UE corresponding to the extreme coverage class identifies UE_group_per_CoverageClass that is set to 010, then the UE may recognize that the UE is designated as the UE group B.

Next, a case where an RACH resource is allocated for each UE group according to an embodiment of the present disclosure will be proposed. For example, it is assumed that an available RACH resource is designated in advance for each UE group. In this case, the RACH configuration information may include, for example, a UE class, an MCS index, etc., corresponding to a UE group. Herein, the UE class is information for identifying the above-described UE group. For example, assuming that there are two UE groups, a UE class may indicate a UE group by one bit. The MCS index indicates an MCS to be used by a UE group in random access, and is included in an MCS table used by the UE group. For example, if the size of an MCS table is 8, an MCS index included in RACH configuration information may be expressed by 3 bits. According to another embodiment, it is assumed that an RACH resource available for each UE group is not designated in advance, but an RACH resource specific for each UE group is allocated. In this case, the RACH configuration information may include, for example, a UE class, an MCS index, a frequency indicator, a time indicator, the number of slots allocated to an RACH, and so forth. Herein, the UE class and the MCS index are defined identically to a previous embodiment, and the frequency indicator and the time indicator indicate frequency axis and time axis information of an RACH resource allocated to the UE class of the UE receiving each RACH configuration information.

According to another embodiment, it is assumed that an RACH resource for each UE group is not designated in advance, but a UE group-specific RACH resource is shared. In this case, an RACH configuration resource may include, for example, MCS indices of both UE classes, a frequency indicator, a time indicator, the number of slots allocated to an RACH, etc. Herein, MCS indicators may sequentially indicate MCSs allocated to correspond to the number of UE groups. For example, suppose that if two UE groups exist, MCS indicators are configured with a total of 4 bits. In this case, the first 2 bits indicate an MCS allocated to the first UE group and the last 2 bits indicate an MCS allocated to the second UE group. The frequency indicator, the time indicator, and the number of slots allocated to an RACH are defined identically to the previous embodiment, and thus will not be described repetitively.

Next, a case where an available RACH resource is allocated for each coverage class according to an embodiment of the present disclosure will be proposed. In this case, the coverage class may be determined by the BS or the UE according to an embodiment. If the UE determines its coverage class, the UE may determine its coverage class based on a path loss with the BS. Each coverage class according to an embodiment of the present disclosure may use a different MCS, and MCS information allocated to each coverage class may include, for example, a modulation scheme, a code rate, the number of repetitions, a spreading length, and so forth. More specifically, an assumption will be made of a case where an RACH resource is specified for each coverage class according to an embodiment of the present disclosure. In this case, the RACH configuration information may include, for example, a coverage class, an MCS index, etc. The MCS index indicates an MCS to be used by UEs having a corresponding coverage class. Suppose that an RACH resource is not specified for each coverage class according to another embodiment of the present disclosure. In this case, the RACH configuration information may include, for example, a coverage class, an MCS index, a frequency indicator, and a time indicator, etc. Herein, the frequency indicator and the time indicator indicate frequency and time locations of each allocated RACH resource.

Each UE according to an embodiment of the present disclosure may be included in one of multiple UE groups, or may be included in one of multiple coverage classes. Alternatively, according to an embodiment, each UE may be included in both of one UE group and one coverage class. According to an embodiment of the present disclosure, each of UE groups uses its unique different MCS table. Herein, when each UE group uses a different MCS table, it means that an available MCS scheme differs from UE group to UE group. For example, it is assumed that there are two UE groups, UE groups A and B. In this case, the UE group A may be configured to use binary phase shift keying (BPSK) and quadrature phase shift keying (QPSK), and the UE group B may be configured to use QPSK and 16 quadrature amplitude modulation (QAM). In another example, the UE group A may be configured to use BPSK and QPSK, and the UE group B may be configured to use frequency and QAM (FQAM). FQAM refers to a combination of frequency shift keying (FSK) and QAM, in which one or more frequencies may be selected from among a plurality of selectable frequency subcarriers in signal transmission.

Suppose a case where there are a UE group A including UEs capable of transmitting a signal through multiple carriers and a UE group B including UEs capable of transmitting a signal through a single carrier, as an embodiment of a UE group according to an embodiment of the present disclosure. As another embodiment of a UE group, an assumption may be made of a case where there are a UE group A including UEs transmitting a signal using multiple carriers and a single carrier and a UE group B including UEs transmitting a signal by using a single carrier. According to another embodiment, some UEs may transmit multiple carriers and a single carrier and determine a UE group to which they are to belong depending on a circumstance. For example, if a UE capable of transmitting multiple carriers and a single carrier desires to transmit a signal by using a single carrier, the UE may operate as the UE group B. In this case, if receiving RACH configuration information from the BS, the UE may receive location and configuration information of an RACH resource corresponding to the UE group B in the RACH configuration information and perform random access with the BS. Thus, the BS may allocate a resource to the UE group A with an MCS corresponding to multiple tones after an RACH, and a resource to the UE group B with an MCS corresponding to a single tone after the RACH. As a result, the BS according to an embodiment of the present disclosure allocates a different MCS table for each UE group.

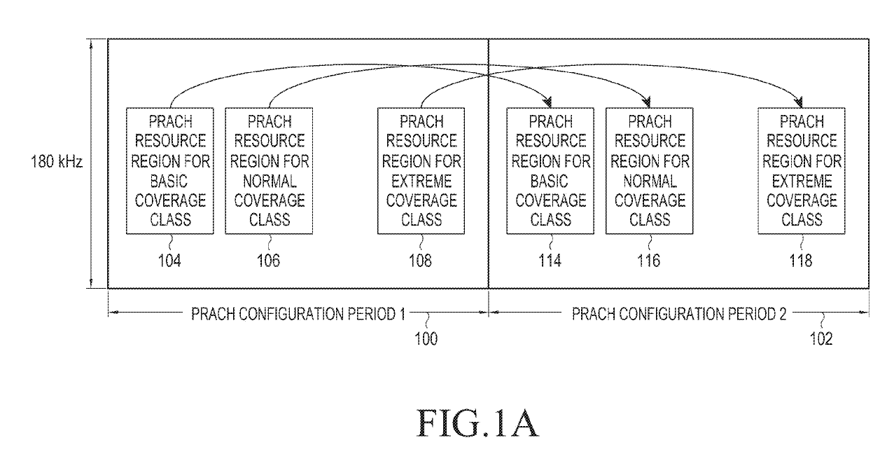

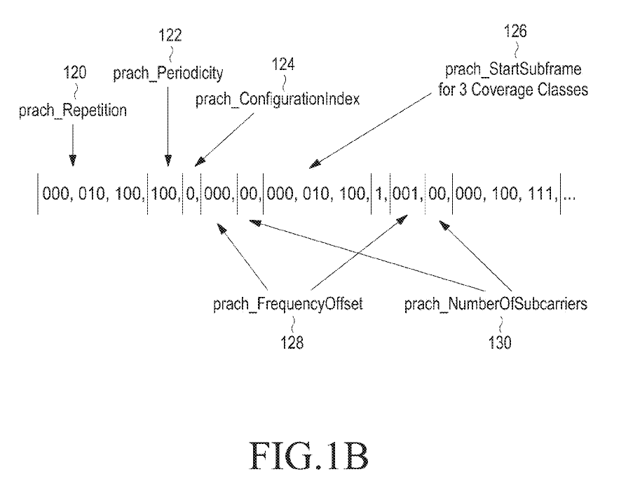

In an embodiment of the present disclosure, when a UE supporting an MTC function for an uplink allocates a resource, a resource (hereinafter, referred to as a PRACH resource) or region for a physical random access channel (PRACH) may be configured to allow UEs to periodically access a system. The PRACH region according to an embodiment of the present disclosure may be configured differently for a different coverage class. FIG. 1A illustrates an example of a PRACH resource configuration allocated based on three coverage classes according to an embodiment of the present disclosure.

Referring to FIG. 1A, as a detailed example, a PRACH resource region for each coverage class may be allocated to have an arbitrary time interval in a predetermined PRACH configuration period. For example, it is assumed that three coverage classes include basic, normal, and extreme coverage classes. In this case, a PRACH resource region 104 for a basic coverage class, a PRACH resource region 106 for a normal coverage class, and a PRACH resource region 108 for an extreme coverage class may be divided by an arbitrary time interval in each PRACH configuration period 100. Likewise, in a next PRACH configuration period 102, a PRACH resource region 114 for a basic coverage class, a PRACH resource region 116 for a normal coverage class, and a PRACH resource region 118 for an extreme coverage class may be allocated to have an arbitrary time interval.

Preamble-based transmission is considered broadly for PRACH transmission. A physical layer random access preamble may include, for example, a cyclic prefix having a length T_CP and a sequence part having a length T_SEQ. If transmission of a preamble for a random access is triggered by a medium access control (MAC) layer, a PRACH resource or region is limited to particular time and frequency resources. Thus, PRACH configuration information corresponding to a PRACH according to an embodiment of the present disclosure may be identified by a PRACH configuration index prach-ConfigurationIndex indicating PRACH configuration information in a frame. Herein, the PRACH configuration information may be configured by a higher layer, and according to an embodiment, the PRACH configuration information may include a PRACH configuration index prach-ConfigurationIndex corresponding to each coverage class level, a PRACH frequency offset prach-FrequencyOffset, and prach_Repetition indicating the number of PRACH repetitions, and selectively, a start sub frame of a PRACH configuration period. In another example, it is assumed that there are two UE groups for UEs. For example, if there are a UE group 1 including UEs supporting only single-tone transmission and a UE group 2 including UEs supporting multi-tone transmission, a set of PRACH resources, PRACH format, and/or PRACH preambles may be set differently for each UE group. In this case, the BS may know a capability of a UE corresponding to a UE group of each UE based on a preamble of the UE.

According to another embodiment, the PRACH configuration information may include, for example, prach-ConfigurationIndex, prach-FrequencyOffset for indicating a frequency resource location of a PRACH for each UE group, prach_Repetition for each UE group, prach_StartingSubframe for each UE group, a PRACH period prach_Periodicity for each UE group, a frequency axis resource size for each UE group, e.g., prach_NumberOfSubcarriers indicating the number of sub carriers for a PRACH resource, and so forth.

According to an embodiment, prach_Periodicity may be expressed by, for example, 3 bits, and may include information about single or multiple elements from among elements forming a predetermined period set {40, 80, 160, 240, 320, 640, 1280, 2560} ms. prach_Repetition may be expressed by, for example, 3 bits, and may include information about single or multiple elements from among elements forming a set of predetermined repetition numbers {1, 2, 4, 8, 16, 32, 64, 128}. prach_FrequencyOffset may also be expressed by, for example, 3 bits, and may include information about single or multiple elements from among elements forming a set of predetermined frequency offsets {1, 0, 12, 24, 36, 2, 18, 34}. prach_NumberOfSubcarriers may be expressed by, for example, 2 bits, and may include information about single or multiple elements from a set of predetermined subcarrier numbers {12, 24, 36, 48}. According to an embodiment, if a UE group does not support multi-tone transmission, prach_Repetition may not support elements of {36, 64, 128}.

According to an embodiment of the present disclosure, if at least one coverage class is defined for each UE group, various repetition levels may be defined for each coverage class corresponding to a UE group. More specifically, for a repetition level for each coverage class, prach_Repetition may include several values instead of one value. For example, the repetition level may be defined as prach_Repetition={0, 1, 2} (or {00, 01, 10}), and a value indicated by each element of prach_Repetition may indicate an index indicating a PRACH repetition number designated in a system, for example, the order of an element among elements forming a set of predetermined repetition numbers {1, 2, 4, 8, 16, 32, 64, 128}. Each UE according to an embodiment of the present disclosure determines its coverage class based on a magnitude of a received signal and identifies a prach_Repetition value corresponding to the determined coverage class. In this case, elements of prach_Repetition may sequentially indicate repetition numbers for basic, normal, and extreme coverage classes. For example, a UE of the extreme coverage class may repeat a random access four times by applying a repetition number of 4 corresponding to the third element in the set of predetermined repetition numbers.

According to another embodiment, a repetition number may be explicitly designated for each coverage class, and in this case, a parameter prach_CoverageClass indicating a repetition number may be additionally transmitted for each coverage class in prach_Configuration.

According to an embodiment of the present disclosure, prach_Repetition for each UE group may be identically or differently defined. A resource location on a frequency and a time of a PRACH resource may be designated differently for coverage classes defined in each group, and corresponding information may be transmitted in prach_FrequencyOffset and prach_StartingSubframe.

FIG. 1B illustrates an example of PRACH configuration information according to an embodiment of the present disclosure.

Referring to FIG. 1B, PRACH configuration information according to an embodiment of the present disclosure may include, for example, continuous bits. More specifically, reference number 120 indicates a set of elements corresponding to prach_Repetition, and each element includes three bits. Reference number 122 indicates a set of elements corresponding to prach_Periodicity, and each element includes three bits. Reference numeral 124 indicates a case where the PRACH configuration information includes 1 bit corresponding to prach-ConfigurationIndex. Reference numeral 126 indicates a set of elements corresponding to prach_StartingSubframe, and each element includes three bits indicating three coverage classes, respectively. Reference numeral 108 indicates three bits indicating prach_FrequencyOffset. Last, reference numeral 110 indicates two bits indicating prach_NumberOfSubcarriers.

According to an embodiment of the present disclosure, it is assumed that the number of coverage classes and the number of elements of predefined prach_Repetition are different from each other. More specifically, suppose that the number of elements forming prach_Repetition is less than the number of coverage classes. For example, the number of elements of a set {0, 2} corresponding to prach_Repetition, 2, is less than the number of three coverage classes, then various mappings may be possible to an RACH repetition number for each coverage class according to an embodiment of the present disclosure. For example, UEs corresponding to basic and normal coverage classes may use, for a random access, the number of repetitions corresponding to the first element of a set including predetermined repetition numbers corresponding to prach_Repetition, and UEs corresponding to an extreme coverage class may use, for a random access, a repetition number corresponding to the second element of the set. In another embodiment, the BS may explicitly designate a coverage class and a repetition number mapped thereto. In this case, prach_CoverageClass and prach_Repetition mapped thereto may be delivered to a UE.

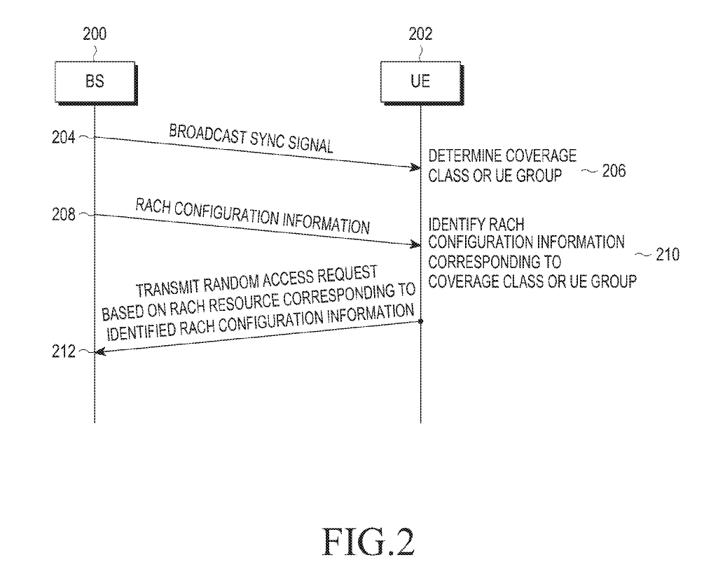

FIG. 2 is an example of a flowchart for determining a coverage class and configuring an RACH according to an embodiment of the present disclosure.

Referring to FIG. 2, in operation 204, a BS 200 transmits a synchronization signal through a broadcasting channel. For convenience, a UE 202 is assumed to be located in a service coverage of the BS 200 and to belong to an arbitrary UE group.

In operation 206, the UE 202 having received a sync signal estimates a path loss based on the sync signal and determines its coverage class based on the estimated path loss. For example, if the estimated path loss falls within a path loss range of the normal coverage class, the UE 202 may recognize that the UE 202 belongs to the normal coverage class.

In operation 208, the BS 200 transmits SI including PRACH configuration information according to an embodiment of the present disclosure through a control channel. Herein, the PRACH configuration information may be configured, for example, in the form as shown in FIG. 1. Parameters included in the PRACH configuration information correspond to the description of FIG. 1, and thus will not be described herein. The SI includes PRACH configuration information allocated for each UE group or coverage class according to the above-described embodiments.

Then, the UE 202 having received the SI identifies prach_Repetition corresponding to its coverage class determined in operation 206, that is, a normal coverage class. According to another embodiment, if the BS 200 informs the UE 202 of the coverage class, the SI may include prach_CoverageClass and prach_Repetition mapped thereto.

Thereafter, the UE 202 identifies a PRACH resource corresponding to PRACH configuration information allocated to its UE group or coverage class from the SI according to an embodiment in operation 212, and delivers a random access request to the BS 200 by using the identified PRACH resource through a PRACH in operation 214.

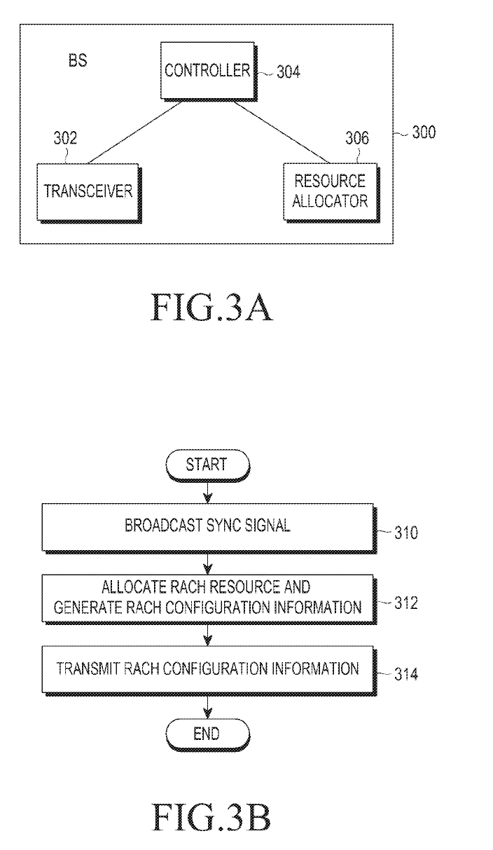

FIG. 3A is a block diagram of a BS according to an embodiment of the present disclosure.

Referring to FIG. 3A, the BS 300 may include a transceiver 302, a controller 304, and a resource allocator 306. Such a configuration of the BS 300 has been described as an example, and a detailed configuration of the BS 300 may be divided into sub units performing corresponding functions or some units may be integrated into one unit, depending on an operator's intention or embodiment.

FIG. 3B is an example of a flowchart illustrating operations of a BS according to an embodiment of the present disclosure.

Referring to FIG. 3B, in operation 310, the controller 304 broadcasts a sync signal through the transceiver 302. In operation 312, the resource allocator 306 allocates an RACH resource based on at least one of a UE group and a coverage class and generates RACH configuration information corresponding to the RACH resource according to one of the above-described embodiments. Herein, the RACH configuration information may be configured as shown in FIG. 1B, and a definition of each parameter included in the RACH configuration information is the same as the foregoing description and thus will not be provided again.

In operation 314, the transceiver 302 transmits the RACH configuration information under control of the controller 304. For example, the RACH configuration information may be broadcast through the SI in a control channel.

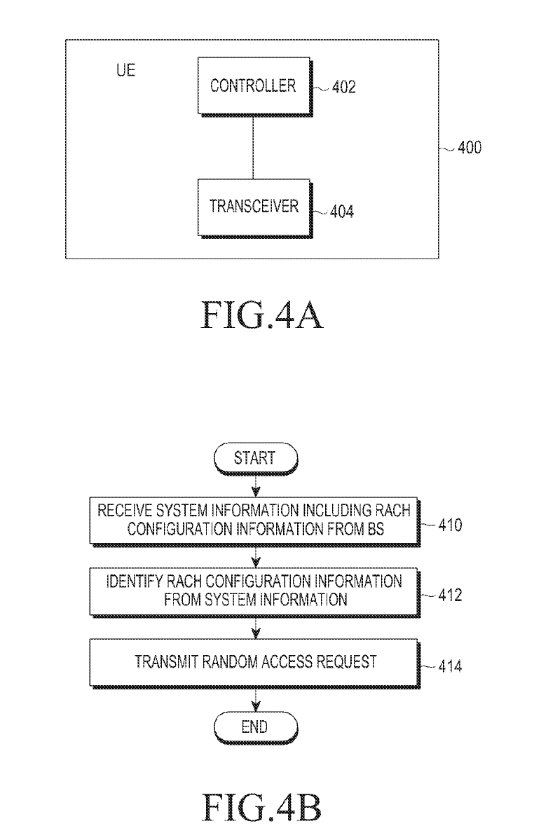

FIG. 4A is a block diagram of a UE according to an embodiment of the present disclosure.

Referring to FIG. 4A, a UE 400 may include a controller 402 and a transceiver 404. Such a configuration of the UE 400 has been described as an example, and a detailed configuration of the UE 400 may be divided into sub units performing corresponding functions or some units may be integrated into one unit, depending on an operator's intention or embodiment.

FIG. 4B is an example of a flowchart illustrating operations of a UE according to an embodiment of the present disclosure.

Referring to FIG. 4B, in operation 410, the transceiver 404 receives SI including RACH configuration information from a BS. Then, in operation 412, the controller 402 obtains the RACH configuration information from the SI. In this case, the controller 402 identifies a UE group or coverage class to which the UE 400 belongs according to an embodiment, and identifies RACH configuration information corresponding to the identified UE group or coverage class. The RACH configuration information corresponding to the identified UE group or coverage class is mapped and allocated to a corresponding UE group or coverage class according to one of the above-described embodiments.

In operation 414, the transceiver 404 transmits a random access request to the BS based on the identified RACH configuration information.

According to an embodiment of the present disclosure described above, a UE performs random access to a BS based on an RACH resource allocated considering at least one of a UE group and a coverage class. Hence, in an embodiment of the present disclosure, a resource in a limited communication system may be more efficiently used according to capabilities r characteristics of the UE.

Particular aspects of the present disclosure may be implemented with a computer-readable code on a computer-readable recording medium. The computer readable recording medium may be any type of data storage device that may store data readable by a computer system. Examples of record-mediums readable by the computer may include a read-only memory (ROM), a random-access memory (RAM), compact disk ROM (CD-ROM), magnetic tapes, floppy disks, optical data storage devices, carrier waves (such as data transmission through the Internet). The computer readable recording medium may be distributed through computer systems connected over a network, and thus the computer readable code is stored and executed in a decentralized manner. Further, functional programs, codes and code segments for achieving the present disclosure may be easily interpreted by programmers skilled in the art which the present disclosure pertains to.

The apparatus and method according to an embodiment of the present disclosure may be implemented by hardware, software, or a combination of hardware and software. Such arbitrary software may be stored, whether or not erasable or re-recordable, in a volatile or non-volatile storage such as a read-only memory (ROM), a memory such as a random access memory (RAM), a memory chip, a device, or an integrated circuit; and an optically or magnetically recordable and machine (e.g., computer)-readable storage medium such as a compact disc (CD), a digital versatile disk (DVD), a magnetic disk, or a magnetic tape. It can be seen that the method according to the present disclosure may be implemented by a computer or a portable terminal which includes a controller and a memory, and the memory is an example of a machine-readable storage medium which is suitable for storing a program or programs including instructions for implementing the embodiment of the present disclosure.

Therefore, the present disclosure includes a program including codes for implementing an apparatus or method claimed in an arbitrary claim and a machine(computer)-readable storage medium for storing such a program. The program may be electronically transferred through an arbitrary medium such as a communication signal delivered through a wired or wireless connection, and the present disclosure properly includes equivalents thereof.

The apparatus according to an embodiment of the present disclosure may receive and store the program from a program providing device connected in a wired or wireless manner. The program providing device may include a memory for storing a program including instructions for instructing the apparatus to execute a preset method, information necessary for the method, a communication unit for performing wired or wireless communication with the apparatus, and a controller for transmitting a corresponding program to the apparatus at the request of the apparatus or automatically.

While embodiments of the present disclosure have been described, various changes may be made without departing the scope of the present disclosure. Therefore, the scope of the present disclosure should be defined by the appended claims and equivalents thereof, rather than by the described embodiments.

1. A method for random access by a user equipment (UE) in a wireless communication system, the method comprising:
receiving, from a base station (BS), configuration information of a resource for the random access allocated based on at least one of a UE group and a coverage class;
identifying the configuration information of the resource for the random access; and
transmitting, to the BS, a random access request using the resource for the random access.

2. The method of claim 1, wherein the identifying of the configuration information of the resource for the random access comprises:
identifying at least one of a UE group of the UE and a coverage class of the UE; and
identifying the configuration information of the resource for random access based on at least one of the identified UE group and the identified coverage class.

3. The method of claim 2, wherein the identifying of the UE group of the UE comprises:
obtaining identification information of the UE group included in the configuration information or selecting at least one of predetermined UE groups.

4. The method of claim 1, wherein the UE group is determined based on at least one of capabilities of the UE or coverage classes of UEs.

5. The method of claim 1, wherein each of the UE groups uses a different modulation and coding scheme (MCS).

6. The method of claim 1, wherein the configuration information of the resource comprises at least one of:
an index indicating a random access resource,
a location of a frequency resource used for the random access,
a location of a time resource used for the random access, and
a number of repetitions of random access channels, and
at least one of the location of the frequency resource, the location of the time resource, and the number of repetitions is mapped to identification information of the UE group or the coverage class.

7. The method of claim 1, wherein the UE group uses only a sing carrier for transmission or uses both single carrier and multi-carrier for transmission.

8. A method for random access by a base station (BS) in a wireless communication system, the method comprising:
allocating a resource for the random access based on at least one of a user equipment (UE) group and a coverage class;
transmitting configuration information of the resource for the random access; and
receiving, from a UE, a random access request transmitted using the resource for the random access, which corresponds to the configuration information.

9. The method of claim 8, wherein each of the UE groups uses a different modulation and coding scheme (MCS).

10. The method of claim 8,
wherein the UE group is determined based on at least one of capabilities of UE or coverage classes of UEs located in a coverage of the BS.

11. The method of claim 9, wherein the configuration information for the resource comprises at least one of:
an index indicating a random access resource,
a location of a frequency resource used for the random access,
a location of a time resource used for the random access, and a number of repetitions of random access channels, and
at least one of the location of the frequency resource, the location of the time resource, and the number of repetitions is mapped to identification information of the UE group or the coverage class of the UE.

12. The method of claim 8, wherein the UE group uses only a sing carrier for transmission or uses both single carrier and multi-carrier for transmission.

13. A user equipment (UE) for random access in a wireless communication system, the UE comprising:
a transceiver;
a controller configured to:
receive, from a base station (BS), configuration information of a resource for the random access allocated based on at least one of a UE group and a coverage class,
identify the configuration information of the resource for the random access, and
transmit, to the BS, a random access request using resource for the random access.

14. (canceled)

15. The UE of claim 13, wherein the controller is further configured to:
identify at least one of a UE group of the UE and a coverage class of the UE, and
identify the configuration information of the resource for random access based on at least one of the identified UE group and the identified coverage class.

16. The UE of claim 14, wherein the controller is further configured to obtain identification information of the UE group included in the configuration information or select at least one of predetermined UE groups.

17. The UE of claim 13, wherein the UE group is determined based on at least one of capabilities of UE or coverage classes of UEs.

18. The UE of claim 13, wherein each of the UE groups uses a different modulation and coding scheme (MCS).

19. A base station (BS) for random access in a wireless communication system, the BS comprising:
a transceiver;
a controller configured to:
allocate a resource for the random access based on at least one of a user equipment (UE) group and a coverage class,
transmit configuration information of the resource for the random access, and
receive, from a UE, a random access request transmitted using the resource for the random access, which corresponds to the configuration information.

20. The BS of claim 19, wherein each of the UE groups uses a different modulation and coding scheme (MCS).

21. The BS of claim 19, wherein the UE group is determined based on at least one of capabilities of UEs or coverage classes of UEs located in a coverage of the BS.
